(19) United States
(12) Patent Application Publication
(10) Pub. No.: US 2003/0231623 A1
(43) Pub. Date: Dec. 18, 2003

(54) Routing system in the next generation open network and method of controlling the routing system

(75) Inventors: Jae Eun Ryu, Gunpo-shi (KR); Jin Yon Cho, Gunpo-shi (KR)

Correspondence Address: FLESHNER & KIM, LLP, P.O. BOX 221200, CHANTILLY, VA, 20153, US

(73) Assignee: LG Electronics Inc.

(21) Appl. No.: 10/455,399

(22) Filed: Jun. 6, 2003

(30) Foreign Application Priority Data
Jun. 17, 2002 (KR) 33666/2002

(51) Int. Cl. H04L 12/66

(52) U.S. Cl. 370/352; 370/401

(57) ABSTRACT

The present invention relates to a routing system in the next generation open network and a method of controlling the routing system. More particularly, the present invention relates to mutual communication between media gateway controllers that use different protocols. A method of controlling a routing system in the next generation open network according to one preferred embodiment of the present invention stores information of a number of media gateway controllers that support cooperation of packet network and public switched telephone network (PSTN) in advance and performs routing of call by retrieving a terminating media gateway controller when call request signal is received from an originating media gateway controller. Further, the method of controlling a routing system in the next generation open network supports routing of call between media gateway controllers using different protocols.

### BACKGROUND OF THE INVENTION

1. Field of the Invention

The present invention relates to a routing system in the next generation open network and a method of controlling the routing system. More particularly, the present invention relates to communication between media gateway controllers that use different protocols.

2. Description of the Related Art

FIG. 1 illustrates the next generation open network in the related art. The next generation open network in the related art includes: public switched telephone networks (PSTN) 51, 52; packet network 10; media gateways 21, 22 for relaying data transmission between the PSTN 51, 52 and the packet network 10; media gateway controllers 31, 32 for controlling the media gateways 21, 22; and signaling gateways 41, 42 for processing signals supplied to the media gateway controllers 31, 32.

The originating media gateway 21 receives bearer such as voice, data and etc. through trunk from the PSTN 51 and the terminating media gateway 22 transmits the bearer through trunk to PSTN 52. The media gateway 21, 22 connects channels for transmitting the bearer to the packet network 10 and receiving the bearer from the packet network 10 by performing bearer control signaling according to control of the media gateway controller 31, 32.

The originating media gateway controller 31 receives call request signal through originating signaling gateway 41 from originating PSTN 51 and the terminating media gateway controller 32 transmits call request signal through terminating signaling gateway 42 to terminating PSTN 52. The originating media gateway controller 31 retrieves terminating media gateway controller 32 by translating the call request signal and the terminating media gateway controller 32 retrieves terminating PSTN 52 by translating the call request signal, thereby performing call control signaling.

In other words, originating media gateway controller 31 extracts IP address of the terminating media gateway controller 32 by translating the call request signal received through originating signaling gateway 41 from the originating PSTN 51 and performs call processing with the terminating media gateway controller 32. The terminating media gateway controller 32 that received the call request signal from the originating media gateway controller 31 retrieves terminating PSTN 52 by translating the call request signal and performs call processing through terminating signaling gateway 42 to the terminating PSTN 52.

Bearer independent call control (BICC) protocol or session initiation protocol-telephone (SIP-T) protocol is used as call control protocol between the originating media gateway controller 31 and the terminating media gateway controller 32. Integrated services digital network- user part (ISUP) protocol is used for call control protocol between the media gateway controller 31, 32 and the PSTN (51, 52). (Refer to Multi-service Switching Forum)

Under the above configuration, call control signaling from the originating PSTN to the terminating PSTN is performed, as follows. Call request signal generated from the originating PSTN 51 is transmitted through originating signaling gateway 41 to the originating media gateway controller 31. The originating media gateway controller 31 performs call control signaling to the terminating media gateway controller 32. The terminating media gateway controller 32 transmits the transmitted call request signal through the terminating signaling gateway 42.

Under the same configuration, bearer control signaling from the originating PSTN 51 to the terminating PSTN 52 is performed as follows. The originating media gateway 21 receives bearer through trunk from the originating PSTN 51. The originating media gateway 21 starts signaling for transmitting bearer to the packet network 10 according to control of the originating media gateway controller 31. The terminating media gateway 22 receives bearer control signal from the packet network 10 according to control of terminating media gateway controller 32. The terminating media gateway 22 connects channel for receiving bearer from the originating media gateway according to the received bearer control signal and connects trunk for transmitting bearer to the terminating PSTN 52.

If packet network and PSTN are operated together, call control signaling and bearer control signaling are processed separately.

Signal transmission between the packet network 10 and the PSTN 51, 52 will be explained with reference to FIG. 2 illustrating signal flow chart in detail.

Initial address message (IAM), call request message generated from the originating PSTN 51, is transmitted through the originating signaling gateway 41 to the originating media gateway controller 31 according to ISUP protocol. The originating media gateway controller 31 requests and returns call related bearer information from the originating media gateway 21 and extracts IP address of the terminating media gateway controller 32 by translating the IAM received through the originating signaling gateway 41.

If communication protocol of the retrieved terminating media gateway controller 32 is the BICC protocol, the originating media gateway controller 31 assigns call instance code (CIC) designated between the terminating media gateway controller 32 and the originating media gateway controller 31 in advance to the IAM and transmits bearer information of the originating media gateway 21 and the IAM to the terminating media gateway controller 32.

The CIC is a code for classifying direction of call using BICC protocol and, in general, is designated in advance as format of even number or odd number between each media gateway controller 31, 32. For instance, a CIC for call processed from a media gateway controller A to another media gateway controller B is designated as even number and a CIC for call processed from the media gateway controller B to the media gateway controller A is designated as odd number. The CIC is designated when call begins and the CIC is used for communication between media gateway controllers 31, 32 until the call is terminated.

The terminating media gateway controller 32 that received the IAM from the originating media gateway controller 31, by translating the IAM, extracts IP address of the terminating PSTN 52, IP address of the terminating media gateway 22 and trunk connecting the terminating media gateway 22 and the terminating PSTN 52.

The terminating media gateway controller 32 performs call control signaling to the retrieved terminating PSTN 52, provides the terminating media gateway 22 with trunk information and bearer information received from the originating media gateway controller 31 and requests bearer set-up.

Then, the terminating media gateway 22 performs bearer set-up by transmitting bearer set-up request message (BSRM) to the originating media gateway 21 and informs the terminating media gateway controller 32 of whether or not bearer set-up is completed. The originating media gateway 21 informs the originating media gateway controller 31 of bearer set-up completion.

Originating media gateway controller in the related art needs to be directly connected to the terminating media gateway controller by retrieving terminating media gateway controller based on received call request signal.

Accordingly, there is a problem in that all information of the other media gateway controllers should be stored in each media gateway controller, if a number of media gateway controllers exist.

For instance, there is a problem in that protocols used for communication with other media gateway controller (BICC or SIP-T) and all CIC information when BICC protocol is used for communication should be stored in each media gateway controller. Also, there is another problem in that media gateway should support all protocols for fluent communication because both BICC protocol and SIP-T protocol, protocols for communicating with other media gateway controller, may be used.

### SUMMARY OF THE INVENTION

The present invention is to solve the above-described problems and an object of the present invention is to provide routing system in the next generation open network and method of controlling the routing system that performs routing of calls by storing information of a number of media gateway controllers and information for BICC protocol communication between media gateway controllers in advance and retrieving the terminating media gateway controller when call request message is received from originating media gateway controller.

In order to achieve the above objects, in whole or in parts, there is provided a method of controlling a routing system in the next generation open network that includes a number of media gateway controllers that support cooperation of packet network and public switched telephone network (PSTN), includes: transmitting bearer information from an originating media gateway to an originating media gateway controller; receiving call request signal from the originating media gateway controller; and transmitting the call request signal to a terminating media gateway controller.

Preferably, the method of controlling a routing system in the next generation open network that includes a number of media gateway controllers that support cooperation of packet network and PSTN, further includes: transmitting the call request signal from an originating PSTN to the originating media gateway controller.

Preferably, said transmitting the call request signal to a terminating media gateway controller includes: retrieving the terminating media gateway controller; if the retrieved terminating media gateway controller uses bearer independent call control (BICC) protocol for communicating with a router, retrieving call instance code (CIC) designated in advance between the terminating media gateway controller and the router; and assigning the retrieved CIC to the call request signal and transmitting the call request signal to the terminating media gateway controller.

Preferably, said retrieving the terminating media gateway controller is to extract IP address of the terminating media gateway controller by translating the call request signal received from the originating media gateway controller.

Preferably, the call request signal is an initial address message (IAM) in BICC format.

Preferably, the call request signal, to which the CIC is assigned, is IAM in BICC format and includes the bearer information received from the originating media gateway controller; JAM in integrated service digital network (ISDN) user part (ISUP) format which the originating media gateway controller received; and the CIC.

Preferably, said assigning the retrieved CIC to the call request signal and transmitting the call request signal to the terminating media gateway controller is to assign CIC designed in advance between the routing server and the terminating media gateway controller to the call request signal and to transmit the bearer information and the call request signal, to which the CIC designed between the routing server and the terminating media gateway controller is assigned, to the terminating media gateway controller.

Preferably, if the retrieved terminating media gateway controller uses BICC protocol for communicating with a router, said retrieving CIC designated in advance between the terminating media gateway controller and the router is to extract the CIC by retrieving communication set-up information stored in advance in the routing server.

Preferably, the communication set-up information includes at least one of IP addresses of a number of media gateway controllers, communication protocols, port numbers and CIC codes.

Preferably, said transmitting the call request signal to a terminating media gateway controller includes: extracting IP addresses of a terminating PSTN and the terminating media gateway controller by translating the call request signal; if the terminating media gateway controller uses session initiation protocol-telephone (SIP-T) protocol for communicating with a routing server, transforming the call request signal into INVITE message corresponding to the SIP-T protocol; and transmitting the INVITE message to the terminating media gateway controller.

Preferably, the call request signal is IAM in BICC format.

Preferably, said transmitting the INVITE message to the terminating media gateway controller includes: retrieving communication set-up information of the terminating media gateway controller stored in the routing server in advance; and extracting IP address of the terminating media gateway controller from the communication set-up information.

Preferably, said transmitting the call request signal to a terminating media gateway controller further includes: retrieving IP address of a terminating PSTN by translating the INVITE message received from the router; and transforming the INVITE message into the original call request signal and transmitting the call request signal to the terminating PSTN.

Preferably, said receiving call request signal from the originating media gateway controller is to assign CIC designed in advance between the originating media gateway controller and a routing server to IAM in ISUP format and to transmit IAM in BICC format including the IAM in ISUP format, the bearer information and the CIC.

Preferably, the method of controlling a routing system in the next generation open network that includes a number of media gateway controllers that support cooperation of packet network and PSTN, further includes: translating the call request signal and transmitting the call request signal, that the terminating media gateway controller received, to a terminating PSTN.

Preferably, the method of controlling a routing system in the next generation open network that includes a number of media gateway controllers that support cooperation of packet network and PSTN, further includes: requesting bearer set-up by transmitting bearer information from the terminating media gateway controller to the terminating media gateway; performing bearer set-up by transmitting bearer set-up request message from the terminating media gateway to the originating media gateway; and informing the terminating media gateway controller of whether or not bearer set-up is completed.

In order to achieve the above objects, in whole or in parts, there is provided another method of controlling a routing system in the next generation open network, includes: storing in advance in a routing server communication set-up information of a number of media gateway controllers that support cooperation of packet network and PSTN; extracting IP address of the rouging server by translating call request signal that originating media gateway controller received from originating PSTN and transmitting the call request signal to the routing server; extracting IP address of terminating media gateway controller by translating call request signal that the routing server received from the originating media gateway controller and transmitting the call request signal to the terminating media gateway controller; and retrieving a terminating PSTN by translating the call request signal that the terminating media gateway controller received from the routing server and transmitting the call request signal to the terminating PSTN.

Preferably, said extracting IP address of the rouging server by translating call request signal that originating media gateway controller received from originating PSTN and transmitting the call request signal to the routing server includes: transmitting IAM in ISUP format from the originating PSTN to the originating media gateway controller; transmitting bearer information from the originating media gateway to the originating media gateway controller; extracting IP address of the routing server by translating the IAM; retrieving CIC designated in advance between the routing server and the originating media gateway controller; and assigning the retrieved CIC to the IAM and transmitting IAM in BICC format including the bearer information, the IAM transmitted from the originating PSTN to the originating media gateway controller and the retrieved CIC to the routing server.

Preferably, said extracting IP address of terminating media gateway controller by translating call request signal that the routing server received from the originating media gateway controller and transmitting the call request signal to the terminating media gateway controller includes: transmitting IAM in BICC format from the originating media gateway controller to the routing server; extracting IP address of the terminating media gateway controller by translating the IAM in BICC format; checking communication set-up of the terminating media gateway controller based on communication set-up information stored in advance in the routing server and, if the terminating media gateway controller uses BICC protocol for communicating with the routing server, retrieving CIC designated in advance between the routing server and the terminating media gateway controller; and assigning the CIC to the IAM in BICC format and transmitting IAM in BICC format, including bearer information received from the originating media gateway controller, IAM in ISUP format and the CIC, to the terminating media gateway controller.

Preferably, said extracting IP address of terminating media gateway controller by translating call request signal that the routing server received from the originating media gateway controller and transmitting the call request signal to the terminating media gateway controller includes: transmitting IAM in BICC format from the originating media gateway controller to the routing server; extracting IP address of the terminating media gateway controller by translating the IAM in BICC format; checking communication set-up of the terminating media gateway controller based on communication set-up information stored in advance in the routing server and, if the terminating media gateway controller uses SIP-T protocol for communicating with the routing server, transforming the IAM into INVITE message corresponding to the SIP-T protocol; and transmitting the INVITE message to the terminating media gateway controller.

Preferably, said retrieving terminating PSTN by translating the call request signal that the terminating media gateway controller received from the routing server and transmitting the call request signal to the terminating PSTN includes: transmitting IAM in BICC format from the routing server to the terminating media gateway controller; extracting IP addresses of the terminating PSTN and a terminating media gateway by translating the IAM in BICC format; transmitting the IAM, transmitted from the originating PSTN to the originating media gateway controller, to the terminating PSTN; and transmitting bearer information included in the IAM in BICC format to the terminating media gateway.

Preferably, said retrieving terminating PSTN by translating the call request signal that the terminating media gateway controller received from the routing server and transmitting the call request signal to the terminating PSTN includes: transmitting INVITE message corresponding to SIP-T protocol from the routing server to the terminating media gateway controller; extracting IP address of the terminating PSTN by translating the INVITE message; and transmitting the IAM, transmitted from the originating PSTN to the originating media gateway controller, to the terminating PSTN by transforming the INVITE message into the IAM transmitted from the originating PSTN to the originating media gateway controller.

In order to achieve the above objects, in whole or in parts, there is provided a routing system in the next generation open network, includes: originating media gateway controllers that transmit call request signal received from an originating PSTN; terminating media gateway controllers that retrieve a terminating PSTN by translating the call request signal and transmit the call request signal to the terminating PSTN; and routing servers that have communication set-up information of a number of media gateway controllers, receive the call request signal from the originating media gateway controller and transmit the call request signal to the terminating media gateway controller corresponding to the call request signal.

Preferably, the originating media gateway controller extracts IP address of the routing server by translating IAM in ISUP format received from the originating PSTN, generates IAM in BICC format including bearer information received from the originating media gateway, the IAM in ISUP format and CIC, designated in advance between the routing server and the originating media gateway controller, by assigning the CIC to the IAM in ISUP format and transmits the IAM in BICC format to the routing server.

Preferably, the routing server extracts IP address of a terminating media gateway controller by translating the IAM in BICC format received from the originating media gateway controller, assigns CIC designated in advance between the routing server and the terminating media gateway controller to the IAM in BICC format if the terminating media gateway controller retrieved based on the communication set-up information stored in advance uses BICC protocol for communicating with the routing server, and transmits IAM in BICC format, that includes the bearer information received from the originating media gateway controller, the IAM in ISUP format and the CIC, to the terminating media gateway controller.

Preferably, the routing server extracts IP address of a terminating media gateway controller by translating the IAM in BICC format received from the originating media gateway controller, transforms the IAM in BICC format into INVITE message corresponding to the SIP-T protocol if the terminating media gateway controller retrieved based on the communication set-up information stored in advance uses SIP-T protocol for communicating with the routing server, and transmits the INVITE message to the terminating media gateway controller.

### BRIEF DESCRIPTION OF THE DRAWINGS

FIG. 1 briefly illustrates a related art next generation open network.

FIG. 2 illustrates signal flows corresponding to co-operation between packet network and PSTN in the related art next generation open network.

FIG. 3 illustrates the next generation open network including a routing system according to one preferred embodiment of the present invention.

FIG. 4 is a flow chart illustrating operations controlling call request signal in the routing server.

FIG. 5 is a flow chart illustrating operations controlling call request signal in originating media gateway controller.

FIG. 6 is a flow chart illustrating operations controlling call request signal in routing server.

FIG. 7 is a flow chart illustrating operations controlling call request signal in terminating media gateway controller.

FIG. 8 illustrates signal flows corresponding to co-operation between packet network and PSTN in the next generation open network including a routing system according to a preferred embodiment of the present invention.

FIG. 9 illustrates signal flows corresponding to co-operation between packet network and PSTN in the next generation open network including a routing system according to another preferred embodiment of the present invention.

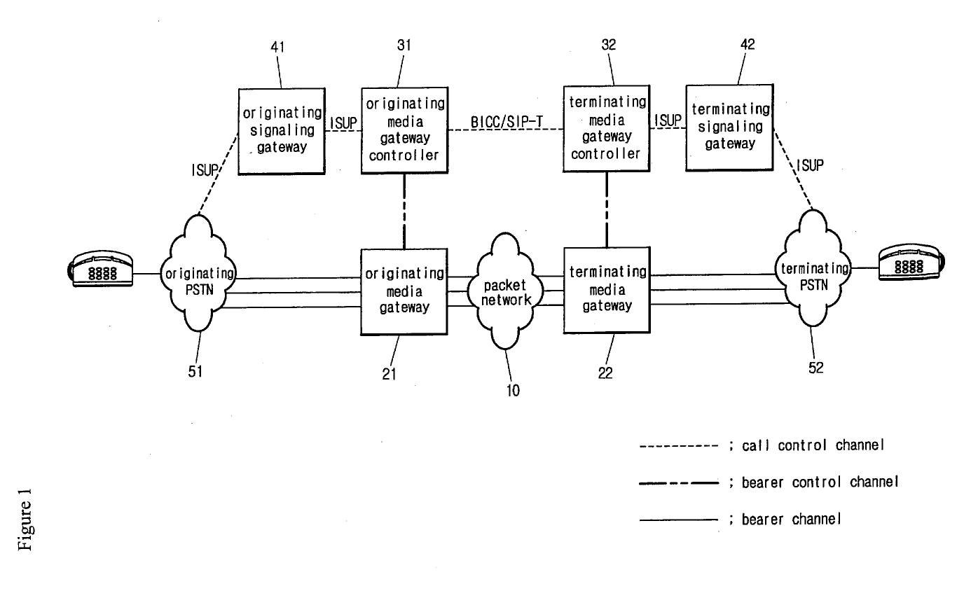

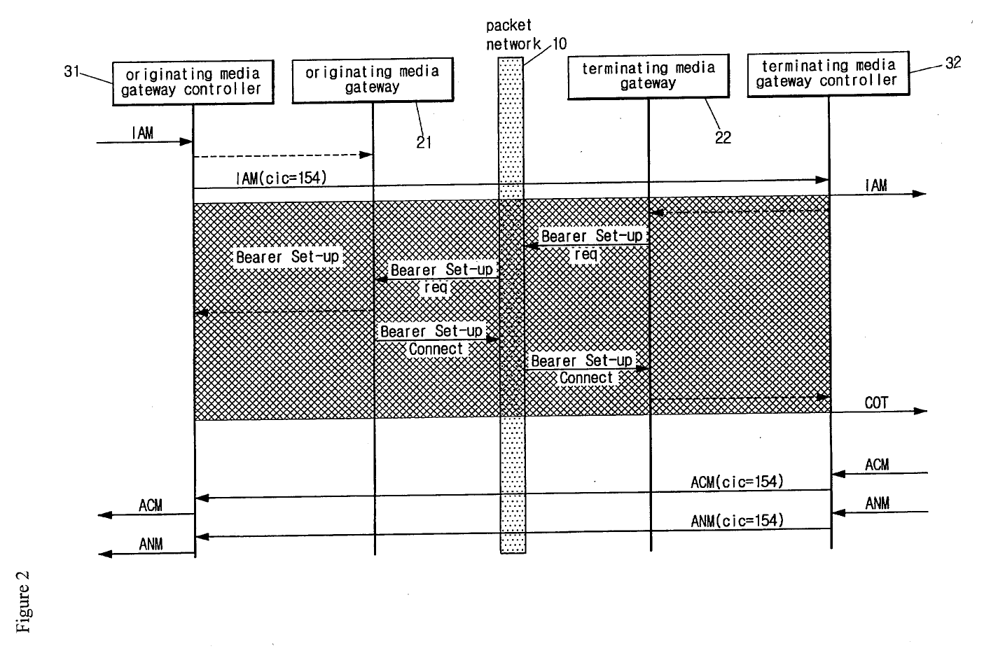

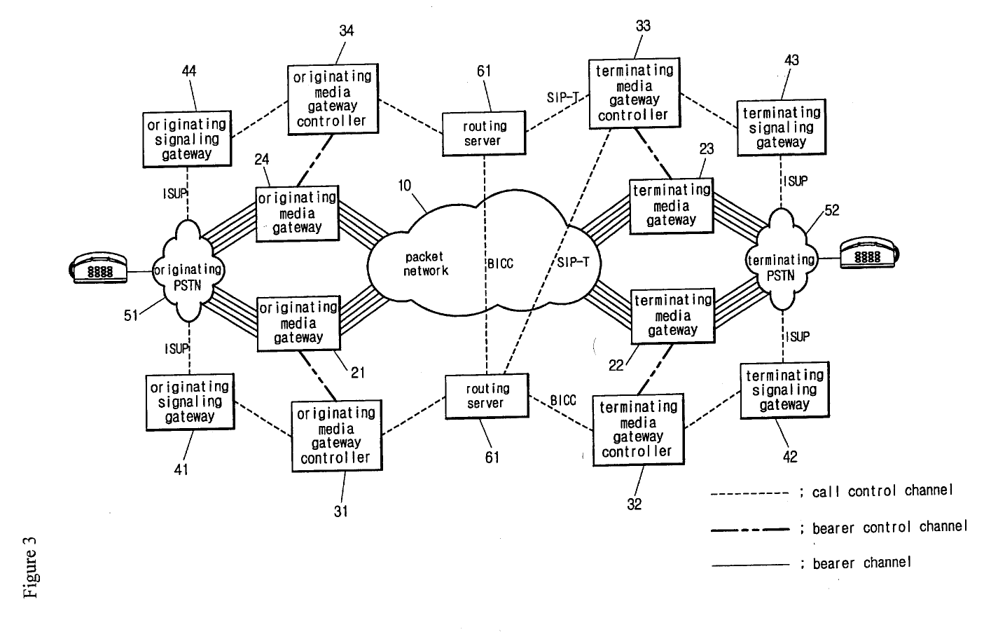

### DETAILED DESCRIPTION OF THE PREFERRED EMBODIMENT

Hereinafter, a detailed explanation will be given as to the preferred embodiment of the present invention with reference to the attached drawings.

A routing system in the next generation open network according to one preferred embodiment of the present invention further includes a routing server 61 for supporting communication between media gateway controllers.

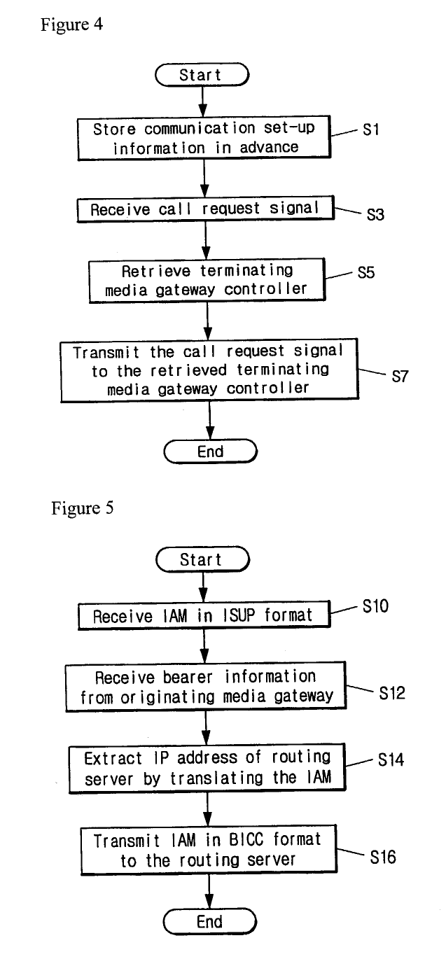

FIG. 4 is a flow chart illustrating operations controlling call request signal in the routing server 61.

First, communication set-up information for communicating with media gateway controllers 31, 32, 33, 34 and the other routing servers is stored in advance in the routing server 61 (SI). The routing server 61 receives call request signal and bearer information from originating media gateway controller 31 or 34 (S3) and retrieves terminating media gateway controller 32 or 33 corresponding to the received call request signal (S5). If the terminating media gateway controller 32 or 33 is retrieved, the routing server 61 transmits the call request signal and the bearer information to the terminating media gateway controller 32 or 33 corresponding to the communication set-up information stored in advance (S7), so that the originating media gateway controller 31 or 34 and the terminating gateway controller 32 or 33 are connected to each other.

The communication set-up information of media gateway controller 31, 32, 33, 34 and the other routing servers stored in the routing server 61 includes IP addresses of each element, communication protocols, port numbers allotted to the elements and CICs designated in advance for BICC protocol communication. The information stored in the routing server 61 is illustrated in Table 1.

TABLE 1
Routing Server (#61)

| index | Ip Address | Port Number | Protocol | CIC (if BICC) |
|---|---|---|---|---|
| 1 | 654.654.654.1 (#61) | 3097 | BICC | Even |
| 2 | 134.122.52.13 (#33) | 5060 | SIP | — |
| 3 | 123.123.57.12 (#34) | 3097 | BICC | Odd |

As illustrated in Table 1, IP addresses of a number of media gateway controllers 31, 32, 33, 34 and the other routing servers; communication protocols used for each element; port numbers; and CICs are stored in the routing server 61. Table 1 illustrates just a few elements, such as one routing server and media gateway controllers 33, 34. However, communication set-up information of a number of routing servers and media gateway controllers in the network may be stored.

Communication set-up information for communicating with a number of routing servers in the network is stored in the originating media gateway controller 31, 34. The communication set-up information stored in the originating media gateway controller 31, 34 includes IP addresses of each routing server, communication protocols, port numbers allotted to the routing server and CICs designated in advance for BICC protocol communication. Accordingly, information stored in the originating media gateway controller 31, 34 may be illustrated in Table 2.

TABLE 2
Originating Media Gateway Controller (#34)

| Index | Ip Address | Port Number | Protocol | CIC (if BICC) |
|---|---|---|---|---|
| 1 | 456.456.456.1 (#61) | 3097 | BICC | Even |

As illustrated in Table 2, IP address of the routing server 61 in the network, protocol of the routing server 61, port number of the routing server 61 and CIC are stored in the originating media gateway controller (#34). Table 2 illustrates information of just one routing server 61. However, communication set-up information of a number of routing servers in the network may be stored practically.

If call request signal is received from originating PSTN 51 through originating signaling gateway 41, 44, the originating media gateway controller 31, 34 extracts IP address of routing server by translating the call request signal and transmits the call request signal to the routing server 61.

For instance, if IP address of the routing server extracted by translating the call request signal is 456.456.456.1, the originating media gateway controller 31, 34 assigns even number as CIC and transmits the call request signal and bearer information of the originating media gateway 21, 24 to port 3097 of the routing server 61.

The routing server 61 extracts IP address of terminating media gateway controller 32, 33 by translating call request signal received from the originating media gateway controller 31, 34 and checks CIC designated in advance between the routing server 61 and the terminating media gateway controller through communication set-up information when BICC protocol is used for communication between the routing server 61 and the terminating media gateway controller 32, 33. The routing server 61 transmits bearer information of the originating media gateway 21 and IAM to the terminating media gateway controller 32 according to the extracted CIC.

If protocol for communication between the routing server 61 and the terminating media gateway controller 33 is SIP-T, the routing server 61 transmits the SIP-T messages to the terminating media gateway controller 33 by transforming all BICC messages received from the originating media gateway controller 31, 34 into SIP-T messages. Further, the routing server 61 transmits the INVITE messages and bearer information to the terminating media gateway controller 33 by transforming the call request signal (IAM) received from the originating media gateway controller 31, 34 into INVITE messages corresponding to SIP-T protocol.

For instance, if IP address extracted by translating the call request signal is 654.654.654.1, the routing server 61 should transmit the call request signal to another routing server having the above address. Accordingly, the routing server 61 assigns even number as CIC and transmits the call request signal and the bearer information of the originating media gateway 21, 24 to port 3097 of the routing server having the address. If IP address extracted by translating the call request signal is 134.122.52.13 (#33), the routing server 61 transmits transformed information to port 5060 of the terminating media gateway controller 33 by transforming received call request signal (IAM) into INVITE messages corresponding to SIP-T protocol and by transforming all BICC messages into SIP-T messages, because the terminating media gateway controller 33 uses SIP-T protocol.

The routing server 61 performs routing of the call request signal by extracting IP address of terminating media gateway controller 32, 33 through translating the call request signal and supports communication between media gateway controller using BICC protocol and media gateway controller using SIP-T protocol. The routing server 61 performs translation of call request signal and supports communication between media gateway controllers. However, the routing server 61 does not control bearer.

The terminating media gateway controller 32, 33 that received call request signal from the routing server 61 retrieves terminating PSTN 52 by translating the received call request signal and performs routing of the call to the terminating PSTN 52 through terminating signaling gateway 42, 43.

The terminating media gateway controller 32, 33 has information about a number of routing servers as the originating media gateway controller 31, 34 does. Information stored in the terminating media gateway controller 32, 33 may be illustrated in Table 3.

TABLE 3
Terminating Media Gateway Controller (#33)

| Index | Ip Address | Port Number | Protocol | CIC (if BICC) |
|---|---|---|---|---|
| 1 | 456.456.456.1 (#61) | 5060 | SIP | — |
| 2 | 654.654.654.1 (#61) | 5060 | SIP | — |

Co-operation procedure between packet network and PSTN in the next generation open network will be explained with reference to FIGS. 5 to 9.

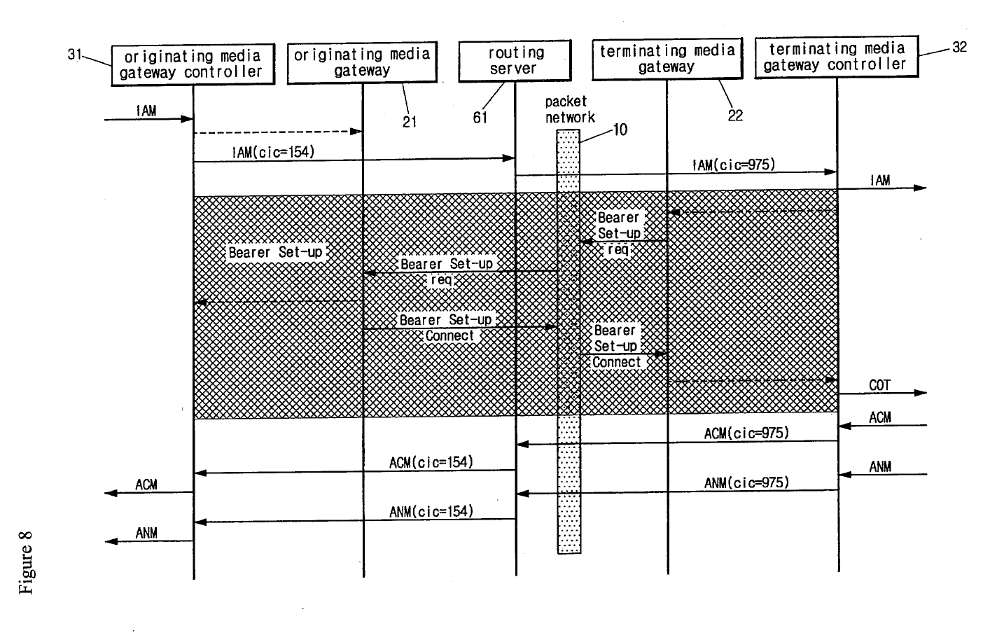

FIG. 8 illustrates signal flows corresponding to co-operation between packet network and PSTN in the next generation open network including a routing system according to a preferred embodiment of the present invention. FIG. 8 illustrates signal flows when all media gateway controllers use BICC protocol for communication with each other.

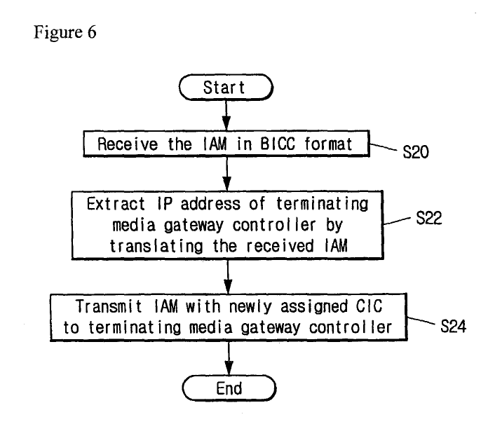

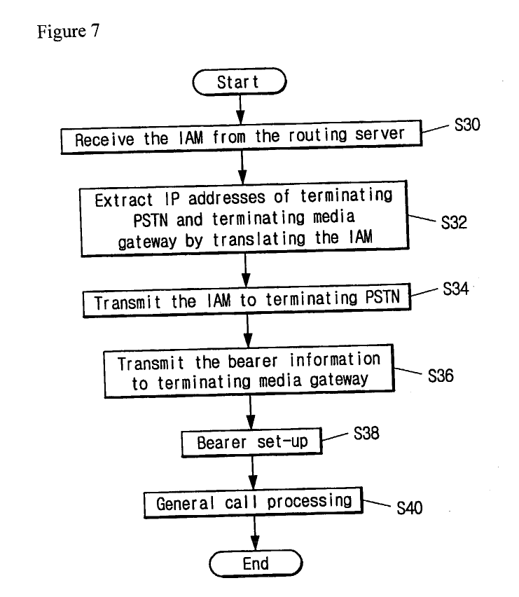

FIG. 8 illustrates signal flows of network, FIG. 5 is a flow chart illustrating operations controlling call request signal in originating media gateway controller, FIG. 6 is a flow chart illustrating operations controlling call request signal in routing server and FIG. 7 is a flow chart illustrating operations controlling call request signal in terminating media gateway controller.

First, with reference to FIGS. 8 and 5, signal flows in the originating media gateway controller 31, 34 will be explained in detail. If the originating media gateway controller 31, 34 receives IAM in ISUP format through originating signaling gateway 41, 44 from originating PSTN 51 (S10), the originating media gateway controller 31, 34 receives bearer information from originating media gateway 21, 24 (S12). The originating media gateway controller 31, 34 extracts IP address of routing server 61 by translating the received IAM (S14) and retrieves communication set-up information of the routing server 61 stored in the originating media gateway controller (Refer to Table 2). The originating media gateway controller 31, 34 assigns CIC designated in advance between the originating media gateway controller and the routing server 61 to the IAM in ISUP format and transmits IAM in BICC format including the bearer information received from the originating media gateway 21, 24, the IAM in ISUP format and the CIC to the routing server 61 (S16).

The routing server 61 receives the IAM in BICC format from the originating media gateway controller 31, 34 (S20), the routing server 61 extracts IP address of the terminating media gateway controller 32 by translating the received IAM (S22). The routing server 61, according to communication set-up information of the terminating media gateway controller 32 stored in advance in the routing server 61 (Refer to Table 1), assigns new CIC to the IAM in BICC format and transmits the IAM in BICC format, to which the new CIC is assigned, including the bearer information received from the originating media gateway 21, 24, the IAM in ISUP format and the newly assigned CIC to the terminating media gateway controller 32 (S24).

The terminating media gateway controller 32 receives the IAM in BICC format from the routing server 61 (S30) and extracts IP address of the terminating PSTN 52, IP address of the terminating media gateway 22 and trunk connecting the terminating PSTN 52 and the terminating media gateway 22 by translating the received IAM in BICC format (S32). The terminating media gateway controller 32 transmits the received IAM through the terminating signaling gateway 42 to the terminating PSTN 52 (S34).

The terminating media gateway controller 32 transmits the bearer information of the originating media gateway 21, 24 included in the received IAM in BICC format to the terminating media gateway 22, in order to set up bearer between each media gateway (S36).

The terminating media gateway 22 sets up bearer connecting the terminating media gateway 22 and the originating media gateway 21, 24 by transmitting bearer set-up request messages (BSRM) to the originating media gateway 21, 24 and informs the terminating media gateway controller 32 of whether or not bearer set-up is completed. The originating media gateway 21, 24 informs the originating media gateway controller 31, 34 of bearer set-up completion (S38).

Call processing procedure after the step S38 is the same as the procedure of processing general ISUP call (S40).

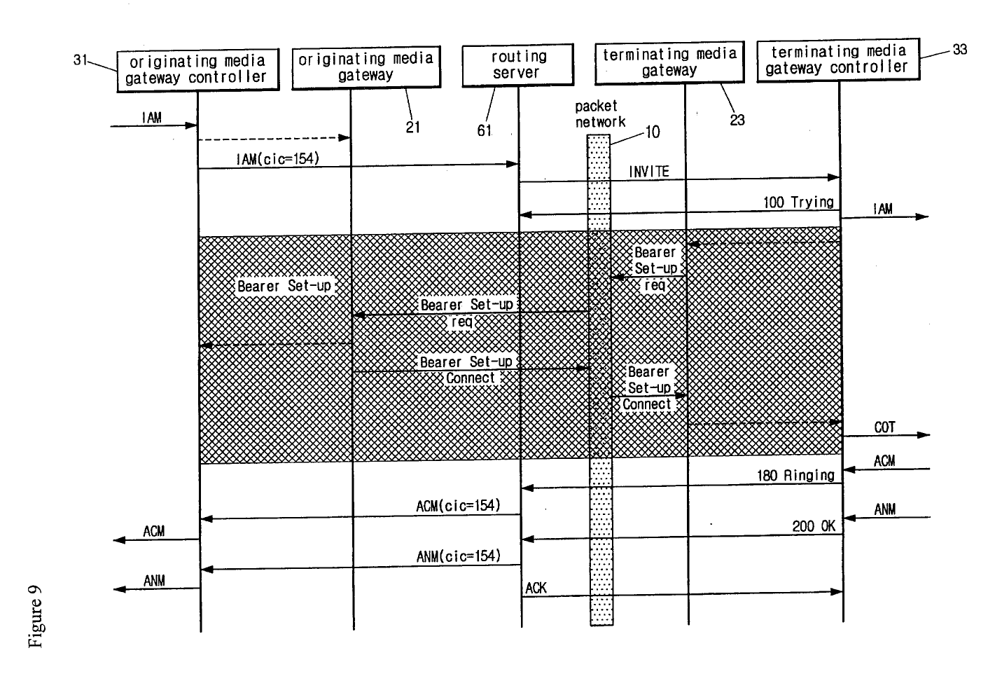

FIG. 9 illustrates signal flows corresponding to co-operation between packet network and PSTN in the next generation open network including a routing system according to another preferred embodiment of the present invention. FIG. 9 illustrates signal flows when media gateway controllers which use different protocols (such as BICC protocol and SIP-T protocol) communicate with each other.

A detailed explanation will be given as to operations in an originating media gateway controller 31, 34. The originating media gateway controller 31, 34 receives IAM in ISUP format through an originating signaling gateway 41, 44 from an originating PSTN 51, the originating-media gateway controller 31, 34 receives bearer information from an originating media gateway 21, 24. The originating media gateway controller 31, 34 extracts IP address of the routing server 61 by translating the received IAM in ISUP format and retrieves communication set-up information for communicating with the routing server 61 (Refer to Table 2). The originating media gateway controller 31, 34 assigns CIC designated in advance between the originating media gateway controller 31, 34 and the routing server 61 to the IAM in ISUP format and transmits IAM in BICC format including the bearer information received from the originating media gateway 21, 24, the IAM in ISUP format and the CIC to the routing server 61.

The routing server 61 extracts IP address of terminating media gateway controller 33 by translating the IAM in BICC format received from the originating media gateway controller 31, 34. The routing server 61 checks communication protocol between the routing server and the terminating media gateway controller 33 based on communication set-up information (Refer to Table 1) of the terminating media gateway controller 33 stored in advance in the routing server 61.

In a case where the protocol between the routing server and the terminating media gateway controller 33 is SIP-T protocol, the routing server 61 transforms the IAM in BICC format received from the originating media gateway controller 31, 34 into INVITE messages corresponding to SIP-T protocol and transmits the INVITE messages to the terminating media gateway controller 33.

The terminating media gateway controller 33 transmits 100 trying message to the routing server 61 in response to the INVITE messages received from the routing server 61. The terminating media gateway controller 33 extracts IP address of the terminating PSTN 52, IP address of the terminating media gateway 23 and trunk connecting the terminating PSTN 52 and the terminating media gateway 23 by translating the received INVITE messages.

The terminating media gateway controller 33 transforms the received INVITE messages to IAM and transmits the IAM to the terminating PSTN 52 through the terminating signaling gateway 43. The terminating media gateway controller 33 requests bearer set-up by transmitting information of the trunk and bearer information of the originating media gateway 21, 24 to the terminating media gateway 23.

The terminating media gateway 23 sets up bearer connecting the originating media gateway 21, 24 and the terminating media gateway 23. The originating media gateway 21, 24 informs the originating media gateway controller 31, 34 of bearer set-up completion and the terminating media gateway 23 informs the terminating media gateway controller 33 of whether or not bearer set-up is completed.

Call processing procedure after the above step is the same as procedure of processing general ISUP call.

According to the present invention, information of a number of media gateway controllers and information for communication between media gateway controllers using BICC protocol is stored in advance. Further, if call request signal is received from the originating media gateway controller, the routing server performs routing of the call by retrieving terminating media gateway controller and supports communication between media gateway controllers.

Accordingly, information of media gateway controller in the network does not need to be stored in each media gateway controller. Further, communication between media gateway controllers using different protocols is made possible. Furthermore, information of a number of media gateway controllers is collectively managed, thereby increasing efficiency of network operation.

The present teaching can be readily applied to other types of systems and methods. The description of the present invention is intended to be illustrative, and not to limit the scope of the claims. Many alternatives, modifications and variations will be apparent to those skilled in the art.

What is claimed is:

1. A method of controlling a routing system in the next generation open network that includes a number of media gateway controllers that support cooperation of packet network and public switched telephone network (PSTN), comprising:
transmitting bearer information from an originating media gateway to an originating media gateway controller;
receiving call request signal from the originating media gateway controller; and
transmitting the call request signal to a terminating media gateway controller.

2. The method of claim 1, further comprising:
transmitting the call request signal from an originating PSFN to the originating media gateway controller.

3. The method of claim 1, wherein said transmitting the call request signal to a terminating media gateway controller comprises:
retrieving the terminating media gateway controller;
if the retrieved terminating media gateway controller uses bearer independent call control (BICC) protocol for communicating with a router, retrieving call instance code (CIC) designated in advance between the terminating media gateway controller and the router; and
assigning the retrieved CIC to the call request signal and transmitting the call request signal to the terminating media gateway controller.

4. The method of claim 3, wherein said retrieving the terminating media gateway controller is to extract IP address of the terminating media gateway controller by translating the call request signal received from the originating media gateway controller.

5. The method of claim 3, wherein the call request signal is an initial address message (IAM) in BICC format.

6. The method of claim 3, wherein the call request signal, to which the CIC is assigned, is IAM in BICC format and comprises the bearer information received from the originating media gateway controller; IAM in integrated service digital network (ISDN) user part (ISUP) format which the originating media gateway controller received; and the CIC.

7. The method of claim 3, wherein said assigning the retrieved CIC to the call request signal and transmitting the call request signal to the terminating media gateway controller is to assign CIC designed in advance between the routing server and the terminating media gateway controller to the call request signal, and to transmit the bearer information and the call request signal, to which the CIC designed between the routing server and the terminating media gateway controller is assigned, to the terminating media gateway controller.

8. The method of claim 3, wherein, if the retrieved terminating media gateway controller uses BICC protocol for communicating with a router, said retrieving CIC designated in advance between the terminating media gateway controller and the router is to extract the CIC by retrieving communication set-up information stored in advance in the routing server.

9. The method of claim 8, wherein the communication set-up information includes at least one of IP addresses of a number of media gateway controllers, communication protocols, port numbers and CIC codes.

10. The method of claim 1, wherein said transmitting the call request signal to a terminating media gateway controller comprises:
extracting IP addresses of a terminating PSTN and the terminating media gateway controller by translating the call request signal;
if the terminating media gateway controller uses session initiation protocol-telephone (SIP-T) protocol for communicating with a routing server, transforming the call request signal into INVITE message corresponding to the SIP-T protocol; and
transmitting the INVITE message to the terminating media gateway controller.

11. The method of claim 10, wherein the call request signal is IAM in BICC format.

12. The method of claim 10, wherein said transmitting the INVITE message to the terminating media gateway controller comprises: retrieving communication set-up information of the terminating media gateway controller stored in the routing server in advance; and extracting IP address of the terminating media gateway controller from the communication set-up information.

13. The method of claim 10, further comprising:
retrieving IP address of a terminating PSTN by translating the INVITE message received from the router; and
transforming the INVITE message into the original call request signal and transmitting the call request signal to the terminating PSTN.

14. The method of claim 1, wherein said receiving call request signal from the originating media gateway controller is to assign CIC designed in advance between the originating media gateway controller and a routing server to IAM in ISUP format and to transmit IAM in BICC format including the IAM in ISUP format, the bearer information and the CIC.

15. The method of claim 1, further comprising:
translating the call request signal and transmitting the call request signal, that the terminating media gateway controller received, to a terminating PSTN.

16. The method of claim 1, further comprising:
requesting bearer set-up by transmitting the bearer information from the terminating media gateway controller to the terminating media gateway;
performing bearer set-up by transmitting bearer set-up request message from the terminating media gateway to the originating media gateway; and
informing the terminating media gateway controller of whether or not bearer set-up is completed.

17. A method of controlling a routing system in the next generation open network, comprising:
storing in advance in a routing server communication set-up information of a number of media gateway controllers that support cooperation of packet network and PSTN;
extracting IP address of the rouging server by translating call request signal that originating media gateway controller received from originating PSTN and transmitting the call request signal to the routing server;
extracting IP address of terminating media gateway controller by translating call request signal that the routing server received from the originating media gateway controller and transmitting the call request signal to the terminating media gateway controller; and
retrieving a terminating PSTN by translating the call request signal that the terminating media gateway controller received from the routing server and transmitting the call request signal to the terminating PSTN.

18. The method of claim 17, wherein said extracting IP address of the rouging server by translating call request signal that originating media gateway controller received from originating PSTN and transmitting the call request signal to the routing server comprises:
transmitting IAM in ISUP format from the originating PSTN to the originating media gateway controller;
transmitting bearer information from the originating media gateway to the originating media gateway controller;
extracting IP address of the routing server by translating the IAM;
retrieving CIC designated in advance between the routing server and the originating media gateway controller; and
assigning the retrieved CIC to the IAM and transmitting IAM in BICC format including the bearer information, the IAM transmitted from the originating PSTN to the originating media gateway controller and the retrieved CIC to the routing server.

19. The method of claim 17, wherein said extracting IP address of terminating media gateway controller by translating call request signal that the routing server received from the originating media gateway controller and transmitting the call request signal to the terminating media gateway controller comprises:
transmitting IAM in BICC format from the originating media gateway controller to the routing server;
extracting IP address of the terminating media gateway controller by translating the IAM in BICC format;
checking communication set-up of the terminating media gateway controller based on communication set-up information stored in advance in the routing server and, if the terminating media gateway controller uses BICC protocol for communicating with the routing server, retrieving CIC designated in advance between the routing server and the terminating media gateway controller; and
assigning the CIC to the IAM in BICC format and transmitting IAM in BICC format, including bearer information received from the originating media gateway controller, IAM in ISUP format and the CIC, to the terminating media gateway controller.

20. The method of claim 17, wherein said extracting IP address of terminating media gateway controller by translating call request signal that the routing server received from the originating media gateway controller and transmitting the call request signal to the terminating media gateway controller comprises:
transmitting IAM in BICC format from the originating media gateway controller to the routing server;
extracting IP address of the terminating media gateway controller by translating the IAM in BICC format;
checking communication set-up of the terminating media gateway controller based on communication set-up information stored in advance in the routing server and, if the terminating media gateway controller uses SIP-T protocol for communicating with the routing server, transforming the IAM into INVITE message corresponding to the SIP-T protocol; and
transmitting the INVITE message to the terminating media gateway controller.

21. The method of claim 17, wherein said retrieving terminating PSTN by translating the call request signal that the terminating media gateway controller received from the routing server and transmitting the call request signal to the terminating PSTN comprises:
transmitting IAM in BICC format from the routing server to the terminating media gateway controller;
extracting IP addresses of the terminating PSTN and a terminating media gateway by translating the IAM in BICC format;
transmitting the IAM, transmitted from the originating PSTN to the originating media gateway controller, to the terminating PSTN; and
transmitting bearer information included in the IAM in BICC format to the terminating media gateway.

22. The method of claim 17, wherein said retrieving terminating PSTN by translating the call request signal that the terminating media gateway controller received from the routing server and transmitting the call request signal to the terminating PSTN comprises:
transmitting INVITE message corresponding to SIP-T protocol from the routing server to the terminating media gateway controller;
extracting IP address of the terminating PSTN by translating the INVITE message; and
transmitting the IAM, transmitted from the originating PSTN to the originating media gateway controller, to the terminating PSTN by transforming the INVITE message into the IAM transmitted from the originating PSTN to the originating media gateway controller.

23. A routing system in the next generation open network, comprising:
originating media gateway controllers configured to transmit call request signal received from an originating PSTN;
terminating media gateway controllers configured to retrieve a terminating PSTN by translating the call request signal and to transmit the call request signal to the terminating PSTN; and
routing servers configured to have communication set-up information of a number of media gateway controllers, to receive the call request signal from the originating media gateway controller and to transmit the call request signal to the terminating media gateway controller corresponding to the call request signal.

24. The system of claim 23, wherein the originating media gateway controller is configured to extract IP address of the routing server by translating IAM in ISUP format received from the originating PSTN, to generate IAM in BICC format including bearer information received from the originating media gateway, the IAM in ISUP format and CIC, designated in advance between the routing server and the originating media gateway controller, by assigning the CIC to the IAM in ISUP format and to transmit the IAM in BICC format to the routing server.

25. The system of claim 24, wherein the routing server is configured to extract IP address of a terminating media gateway controller by translating the IAM in BICC format received from the originating media gateway controller, to assign CIC designated in advance between the routing server and the terminating media gateway controller to the IAM in BICC format if the terminating media gateway controller retrieved based on the communication set-up information stored in advance uses BICC protocol for communicating with the routing server, and to transmit IAM in BICC format, that includes the bearer information received from the originating media gateway controller, the IAM in ISUP format and the CIC, to the terminating media gateway controller.

26. The system of claim 24, wherein the routing server is configured to extract IP address of a terminating media gateway controller by translating the IAM in BICC format received from the originating media gateway controller, to transform the IAM in BICC format into INVITE message corresponding to the SIP-T protocol if the terminating media gateway controller retrieved based on the communication set-up information stored in advance uses SIP-T protocol for communicating with the routing server, and to transmit the INVITE message to the terminating media gateway controller.
